(19) United States
(12) Patent Application Publication
(10) Pub. No.: US 2026/0278877 A1
(43) Pub. Date: Sep. 17, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Takeru KONO, Tokyo (JP); Seiji Shimoyama, Tokyo (JP); Makiko Bujo, Tokyo (JP); Nemu Ozawa, Tokyo (JP)

(73) Assignee: FUJIFILM Business Innovation Corp., Tokyo (JP)

(21) Appl. No.: 19/280,352

(22) Filed: Jul. 25, 2025

(30) Foreign Application Priority Data
Mar. 11, 2025 (JP) 2025-038697

(51) Int. Cl. G06T 11/60; G06V 20/30

(52) U.S. Cl. CPC G06T 11/60; G06V 20/30

(57) ABSTRACT

An information processing system includes a processor configured to: associate attribute information with each page of an album including a plurality of pages; select and present recommended images from images having attribute information associated with each page among a plurality of previously stored images; receive selection of images to be arranged on a corresponding page of the album from the recommended images; and arrange the selected images on the corresponding page of the album.

### CROSS-REFERENCE TO RELATED APPLICATIONS

This application is based on and claims priority under 35 USC 119 from Japanese Patent Application No. 2025-038697 filed Mar. 11, 2025.

### BACKGROUND

### (i) Technical Field

The present invention relates to an information processing system and a non-transitory computer readable medium.

### (ii) Related Art

Japanese Unexamined Patent Application Publication No. 2022-128956 discloses a method of estimating attribute information indicating the preference of a user for the broadcast content on the basis of the viewing history of broadcast content viewed by the user and the subject information included in captured image data, and presenting information in accordance with the estimated attribute information to the user.

### SUMMARY

Recently, with the spread of digital cameras and smartphones, there have been widely provided services for selecting some of a large number of photographs taken by a user and compiling the selected photographs into a photo album. These services mostly use a method in which a user selects photographs and determines a layout for each page.

In these services, however, the user needs to sequentially check a plurality of photographs and select photographs to be arranged on each page of an album, and the selection of photographs takes much time and effort for the user.

Furthermore, if the total number of photographs is large, a scroll-display selection method generally displays photographs in a chronological order. Therefore, photographs displayed at the top are more likely to be selected, while the photographs displayed at the bottom are less likely to be selected. As a result, there is a problem in that the photographs to be finally kept in the album are likely to be biased, thus losing the overall balance of photograph selection.

Aspects of non-limiting embodiments of the present disclosure relate to an information processing system and a non-transitory computer readable medium that are capable of reducing time and effort for a user, when selecting images from a plurality of previously stored images and arranging the selected images on an album including a plurality of pages, to select the images, as compared to a case where the user sequentially checks a plurality of images and selects images to be arranged on each page of an album.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: associate attribute information with each page of an album including a plurality of pages; select and present recommended images from images having attribute information associated with each page among a plurality of previously stored images; receive selection of images to be arranged on a corresponding page of the album from the recommended images; and arrange the selected images on the corresponding page of the album.

### BRIEF DESCRIPTION OF THE DRAWINGS

Exemplary embodiments of the present invention will be described in detail based on the following figures, wherein:

FIG. 1 is a diagram illustrating an example of the entire configuration of an information processing system according to an exemplary embodiment;

FIG. 2 is a diagram illustrating a hardware configuration of a computer according to the exemplary embodiment;

FIG. 3 is a block diagram illustrating a functional configuration of the computer according to the exemplary embodiment;

FIG. 4 is a flowchart of album editing processing executed by the information processing system according to the exemplary embodiment;

FIG. 5 is a diagram illustrating an example of a user screen displayed on a display device according to the exemplary embodiment;

FIG. 6A is a schematic diagram illustrating examples of period information assigned to pages, and FIG. 6B is a schematic diagram illustrating a state in which pages are distributed in accordance with event tags;

FIG. 7 is a diagram for explaining an example of adjustment of a page ratio in accordance with album context information according to the exemplary embodiment; and

FIG. 8 is a diagram illustrating an example of an image recommendation screen displayed on the display device according to the exemplary embodiment.

### DETAILED DESCRIPTION

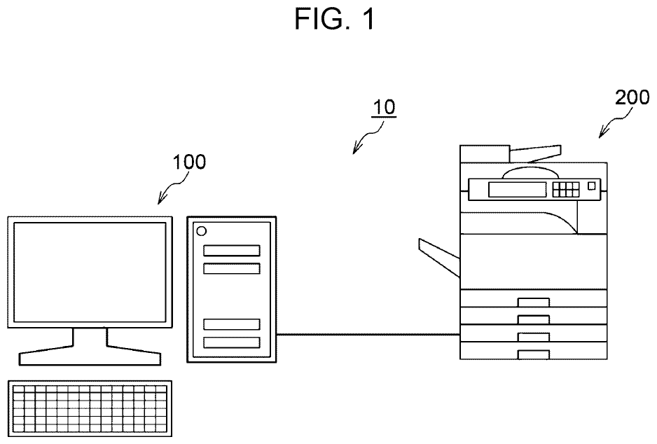

Hereinafter, an information processing system 10 according to an exemplary embodiment of the present disclosure will be described in detail with reference to the drawings. The description will be given assuming that in the present exemplary embodiment, the information processing system 10 includes a computer apparatus 100 and an image forming apparatus 200, as illustrated in FIG. 1. The computer apparatus 100 will be simply referred to as a computer 100 in the following description. The image forming apparatus 200 may be any apparatus such as an on-demand printing machine or a production printer. In the following description, the image forming apparatus 200 will be simply referred to as a printer 200. The computer 100 and the printer 200 are connected to each other directly or via a network such as a local area network (LAN) or the Internet.

The computer 100 may be configured as an information processing apparatus in any form, such as a tablet computer, a smartphone, a desktop personal computer, or a server. In a case where the computer 100 is configured as a server, a user is able to input or display necessary information via a network through a remote computer apparatus or a client terminal such as a smartphone. For example, an album editing operation may be performed on a cloud, so that a plurality of users access the cloud from different devices to perform editing. This allows cooperative editing by a plurality of persons, and efficient presentation of recommended images among a large number of images processed by the server.

The computer 100 executes an album editing program, and creates an album on the basis of an instruction from a user. The printer 200 receives album print data transmitted from the computer 100, and physically prints an album.

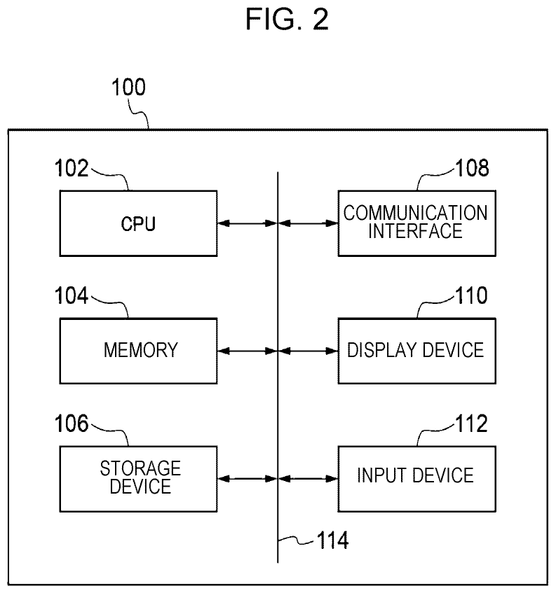

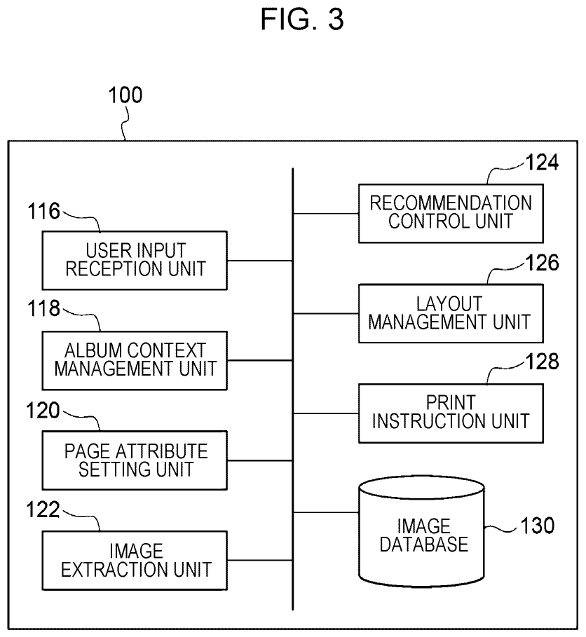

The computer 100 will be described with reference to FIGS. 2 and 3. FIG. 2 is a diagram illustrating a hardware configuration of the computer 100. As illustrated in FIG. 2, the computer 100 includes a central processing unit (CPU) 102, a memory 104, a storage device 106, a communication interface 108, a display device 110, and an input device 112, which are connected to a system bus 114.

The CPU 102 controls and supervises the operation of each unit of the computer 100 on the basis of a control program stored in the storage device 106. This control program forms the album editing program.

The memory 104 stores control program execution data necessary for the operation of the computer 100 and print processing instruction temporary data.

The storage device 106 is formed by a hard disk drive or a solid state drive. The storage device 106 stores a control program for controlling each unit of the computer 100. While the present exemplary embodiment describes a case where the control program is installed in the storage device 106, the present disclosure is not limited to such an embodiment. The control program according to the exemplary embodiment may be provided in a form of being recorded on a computer-readable storage medium. For example, the control program according to the present exemplary embodiment may be provided in a form of being recorded on an optical disc such as a compact disc (CD)-read only memory (ROM) or a digital versatile disc (DVD)-ROM, or in a form of being recorded on a semiconductor memory such as a Universal Serial Bus (USB) memory or a memory card. Further, the control program according to the present exemplary embodiment may be acquired from an external device via a communication line connected to the communication interface 108.

The communication interface 108 performs communication control for communication between the computer 100 and the printer 200. The computer 100 and the printer 200 are connected to each other directly or via a network such as a LAN or the Internet.

The display device 110 is a display such as a liquid crystal monitor, and displays an operation screen and an image recommendation screen for album creation.

The input device 112 includes a keyboard, a mouse, a touchpad, a touch panel, and the like. The input device 112 is an interface used by a user to perform operations on the computer 100. The input device 112 receives an input related to album creation.

FIG. 3 is a functional block diagram of the computer 100. As illustrated in FIG. 3, in the computer 100, the CPU 102 executes the control program stored in the storage device 106. This allows the computer 100 to function as a user input reception unit 116, an album context management unit 118, a page attribute setting unit 120, an image extraction unit 122, a recommendation control unit 124, a layout management unit 126, a print instruction unit 128, and an image database 130.

The user input reception unit 116 receives operations for selecting a purpose of an album and inputting a user's preference through a displayed operation screen. The user input reception unit 116 also receives user's operations for selecting an image and adjusting a layout. Specifically, when a user operates a mouse or a touch panel to perform an operation such as “add this image to a page”, “change a layout”, or “correct event information”, the user input reception unit 116 acquires such an operation content. The user input reception unit 116 notifies the other units of the received operation content to be reflected on album editing.

The album context management unit 118 manages a creation purpose of an album that a user desires to create, and album context information. In the following description, “album context information” will be simply referred to as “context information”. Examples of the creation purpose of an album include “live album”, “yearbook,” and “family album”. The context information includes at least one of a user's preference, a family structure, and event information.

For example, the album context management unit 118 instructs each unit to optimize pages and photographs with reference to various pieces of context information. For example, the album context management unit 118 instructs the recommendation control unit 124 to preferentially recommend photographs in which all family members are shown than other images. With a specific child as a principal person, the album context management unit 118 instructs the page attribute setting unit 120 to distribute a larger number of pages to a month including events for the child. The album context management unit 118 also instructs the page attribute setting unit 120 to distribute a larger number of pages to a month including an event on the calendar or a special event such as consecutive holidays.

The page attribute setting unit 120 sets attribute information for each page on the basis of the total number of pages of an album and the creation purpose thereof. The attribute information includes period information and event information. Examples of the creation purpose of an album include “live album”, “yearbook,” and “family album”. Examples of the attribute information include “period information” and “event information”. The page attribute setting unit 120 assigns attribute information to pages in accordance with the purpose of an album. For example, as the period information, “song” is set for a live album, and “month” is set for a yearbook. In this manner, appropriate attribute information is provided to each page. Furthermore, in the present exemplary embodiment, a user is able to specify the number of pages of an album. The number of pages is specified by a user when, for example, purchasing an album. The page attribute setting unit 120 associates attribute information with pages in accordance with the specified number of pages and the specified number of pieces of attribute information.

Moreover, the page attribute setting unit 120 has a function of associating attribute information with each page of an album including a plurality of pages. Time information may be used as the attribute information associated with each page of the album. The page attribute setting unit 120 distributes the number of pages in the album to which each piece of time information is assigned, in accordance with the total number of pages of the album and the number of pieces of time information. For example, the time information is information of a “month” in which a photograph is taken. For example, in a case where the total number of pages of the album matches the number of months, each page is distributed to one month. In a case where the total number of pages is 24 pages for 12 months, two pages are distributed to each month. If the total number of pages is not divisible by the number of months, the number of pages is increased for a month with a large number of events. Conversely, the number of pages is reduced for a month with a small number of events so as to adjust the overall balance.

The page attribute setting unit 120 increases or reduces a page ratio at which attribute information is associated in accordance with the total number of pages of the album and the context information thereof. For example, the page attribute setting unit 120 refers to the context information held by the album context management unit 118, and reflect a request such as “featuring a family travel event”, and increases the number of pages for a month including a family travel. In a case where the number of images related to a certain period or event is large, the number of pages distributed to such a period or event may be increased. Conversely, the number of pages distributed to a period with a small number of images may be reduced.

Moreover, if a photograph group with specific location information exists, the page attribute setting unit 120 adjusts page distribution in accordance therewith. For example, the number of pages associated with a period including specific location information such as a hot spring travel, may be increased.

Moreover, the page attribute setting unit 120 may adjust a page ratio in the album to which each piece of time information is assigned, in accordance with a ratio of images having time information associated with each page to a plurality of previously stored images. Specifically, the page attribute setting unit 120 may increase the number of pages for a period with a large number of photographs. Conversely, the page attribute setting unit 120 may reduce the number of pages for a period with a small number of photographs.

The image extraction unit 122 extracts an image corresponding to the attribute information associated with each page from a plurality of images previously stored in the image database 130. The extracted image matches the attribute information set by the page attribute setting unit 120. For example, for a page associated with the time information “January” as the attribute information, only images whose photographing date and time as time information belongs to January are extracted. Images of other months are excluded from the candidates. Here, the image extraction unit 122 refers to the photographing date and time, GPS information, an event tag, and the like temporarily stored in the memory 104. In this manner, the corresponding image is efficiently retrieved. Furthermore, the image extraction unit 122 groups photographs that are consecutively taken within a specific period of time. The grouped substantially same or similar photographs are collectively handled, which prevents recommendation of only the same photographs. Then, this prevents the substantially same or similar photographs from filling an album.

From the images extracted by the image extraction unit 122, the recommendation control unit 124 preferentially selects and presents an image in consideration of the context information as a recommended image among other images. That is, the presented image corresponds to the attribute information associated with a specific page and is in accordance with the context information among the plurality of previously stored images. As the context information, a user's preference, an event type, a photographing location, a family structure, or the like is considered. The recommendation control unit 124 selects an image determined to have a high priority as a recommended image, and presents the selected image to a user. For example, in a case of the context information “priority to child growth records”, photographs in which a child is imaged as a large figure are preferentially recommended.

When determining the priority, the recommendation control unit 124 considers the following instructions from the album context management unit 118.
(1) To prioritize an image based on the selection history of other users and the popularity
(2) To prioritize a photograph in which the face of a subject is imaged as a large FIG.
(3) To prioritize a photograph in which all family members are imaged
(4) To prioritize a photograph taken at a specific location, for example, outside the home
(5) To present only a representative image when images are consecutively taken
(6) To prioritize a photograph in which a subject faces the front, and give lower priority to a photograph in which the subject faces backward
(7) To prioritize a photograph in which favorite members are imaged side by side if a user supports a plurality of idol groups

The recommendation control unit 124 dynamically adjusts the order of images to be presented and the candidate list by weighting in accordance with the user's preference and creation purpose based on the instruction from the album context management unit 118.

The layout management unit 126 generates and manages the layout information to be used when arranging images selected by a user on pages of an album. For example, in a case where a plurality of selected images are to be arranged on each page, the size of a frame, an aspect ratio, the arrangement of character strings, and the like are determined, and a preview is displayed. If a user manually changes a layout by drag and drop, the layout management unit 126 stores the change. The stored layout change is reflected in final print data.

The print instruction unit 128 generates print data on the basis of the layout information of the album determined by the layout management unit 126. The print instruction unit 128 transmits the generated print data to the printer 200. The print instruction unit 128 converts data in consideration of the layout information for each page and the print conditions such as a resolution setting, a paper size, and paper quality. Once the user presses a print button, the print instruction unit 128 instructs the printer 200 to start printing.

The image database 130 stores images such as photographs taken or collected by a user. The image database 130 may also store photographs taken by other photographers. The image is not limited to a photograph, and may be an illustration or a computer-generated image. The image database 130 may store metadata associated with each image. Examples of the metadata include a photographing date and time, a photographing location, camera settings, information of a photographer, a keyword, and an event tag. With the use of such metadata, the image extraction unit 122 is able to quickly extract a target image. The image database 130 may be constructed on a cloud storage so as to be accessible via a network.

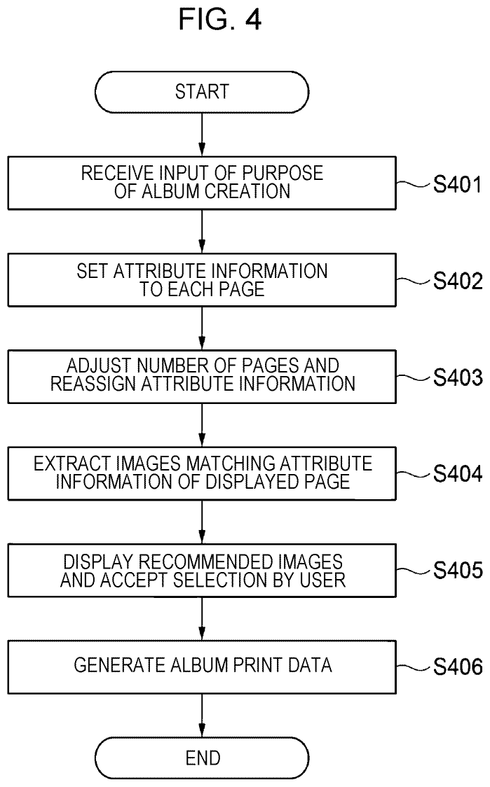

Next, a flow of album editing processing in the computer 100 will be described with reference to FIG. 4. FIG. 4 is a flowchart for describing the album editing processing in the computer 100.

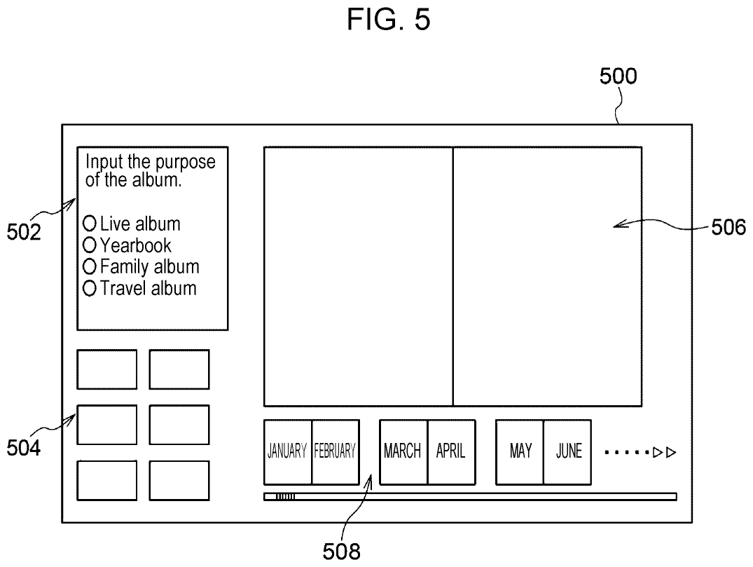

At step S401, the user input reception unit 116 displays a screen for selecting a purpose of album creation on the display device 110. For example, a user screen 500 illustrated in FIG. 5 is displayed. In the upper left field of the user screen, an album creation purpose selection list 502 generated by the user input reception unit 116 is displayed. The album creation purpose selection list 502 is presented in a list form including choices such as “live album”, “yearbook”, “family album”, and “travel album”, for example. A user selects a purpose through the input device 112, and the user input reception unit 116 receives the input.

The album context management unit 118 holds the received purpose information as context information. In this manner, the page attribute setting unit 120, the recommendation control unit 124, and the like to be described later optimize the page constitution and image selection on the basis of the album creation purpose.

A recommended image display field 504 is provided in the lower left field of the screen. At the center of the screen, a page preview area 506 where photographs are arranged by the layout management unit 126 is provided. A page selection field 508 is provided in the lower field of the screen.

At step S402, the page attribute setting unit 120 sets attribute information to be assigned to each page in accordance with the total number of pages of the album. The attribute information is, for example, period information or event information. Specifically, on the basis of the information such as “live album”, “yearbook”, and “family album” held by the album context management unit 118, pages are distributed to respective “songs” in the case of a “live album”. In the case of a “yearbook”, pages are distributed to respective “months”. In the case of a “family album”, pages are distributed to respective “growth stages of a child (for example, school period, grade, anniversary, or the like)”. The total number of pages of the album may be a value specified in any manner by the user at the time of purchase, or may be a default value. In a case where the user specifies the number of periods of a specific event, the page distribution may be automatically determined in accordance with such a number of periods. Examples of the number of periods of an event include the number of periods of an entire live, that is, the number of songs, and the number of months in a yearbook.

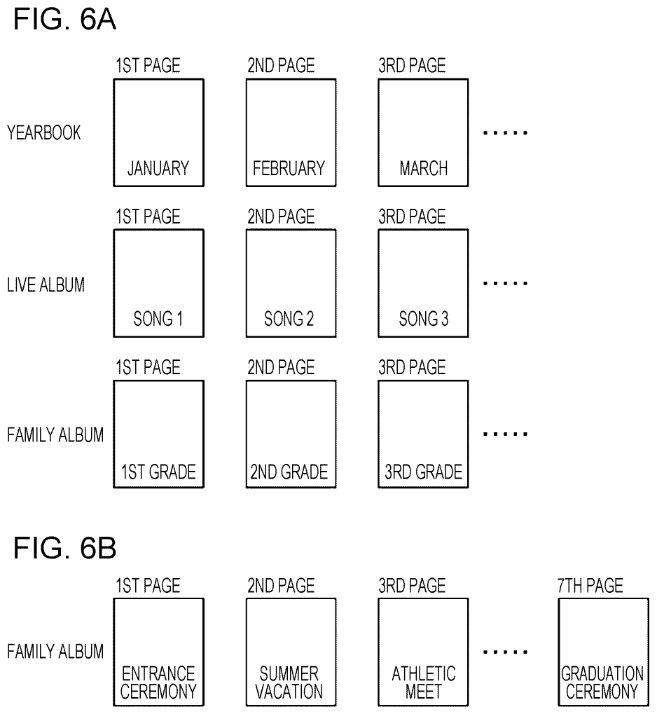

FIG. 6A is a schematic diagram illustrating examples of the attribute information assigned to pages. When the user selects a “yearbook”, the page attribute setting unit 120 assigns an attribute to each page in units of month, such as “January”, “February”, “March”, and the like. Meanwhile, in a “live album”, an attribute is assigned in units of song in the form of “song 1”, “song 2”, “song 3”, and the like. In a “family album”, an attribute is assigned in units of growth stage of a child in the form of “1st grade”, “2nd grade”, “3rd grade”, and the like.

The user may set event tags such as “entrance ceremony”, “summer vacation”, “athletic meet”, and “graduation ceremony” as attribute information. In this case, attribute information may be assigned to each page in accordance with these tags. For example, as illustrated in FIG. 6B, an event tag is assigned to each page of a “family album”. For example, the tags such as “entrance ceremony”, “summer vacation”, “athletic meet”, and “graduation ceremony” are assigned. The page attribute setting unit 120 stores the setting result in the memory 104 or the storage device 106, and passes the setting result to the subsequent image recommendation processing.

In a case where the number of pages is fixed, the number of pages is proportionally distributed on the basis of the number of pieces of attribute information, so that attribute information is associated for as many as the number of pages. For example, if a year album has 24 pages for 12 months, two pages are distributed to each month. Meanwhile, if a live album has 24 pages for six songs, four pages are distributed to each song, for example.

At step S403, the page attribute setting unit 120 adjusts or redistributes the number of pages. For example, if the number of pages is not divisible by the number of event periods, the number of pages is adjusted in consideration of the size of a population of photographs included in each period. Specifically, the page attribute setting unit 120 increases the number of pages for a period with a large number of photographs, and reduces the number of pages for a period with a small number of photographs. That is, the page attribute setting unit 120 refers to a group of images stored in the storage device 106, and adjusts the number of pages if the number of photographs of a specific period or event is extremely large or small. For example, in the case of a “live album”, if the number of photographs of a specific song is large, the number of pages distributed to such a song is increased. In the case of a “family album”, the number of pages for a month having an event in which a child is imaged in a large number of photographs is increased.

At step S403, the page attribute setting unit 120 may adjust the ratio of attribute information to be assigned to pages with reference to the information held by the album context management unit 118. For example, “priority to photographs of a wedding” or “priority to photographs of a travel” is requested, this is reflected. That is, the page attribute setting unit 120 changes the page distribution to each event such as a wedding or a travel while maintaining the total number of pages. This enables a well-balanced album in accordance with the user's wish.

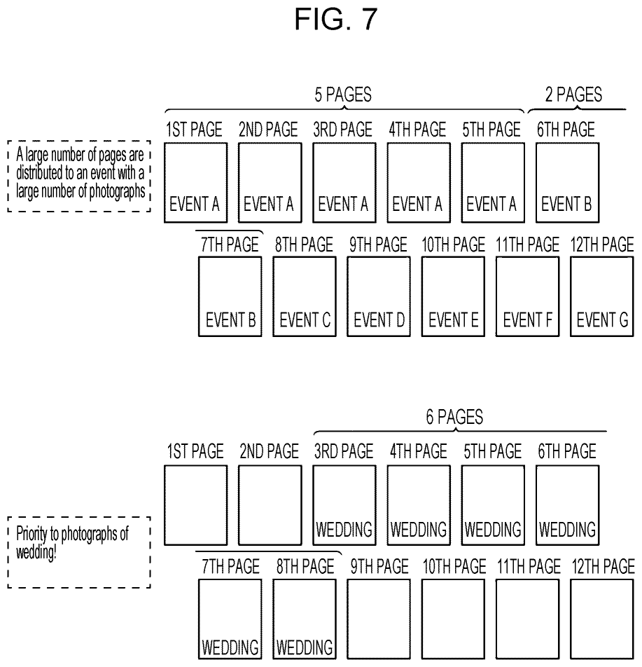

FIG. 7 is a diagram for explaining an example of adjustment of a page ratio in accordance with context information. To create an album having 12 pages, for example, the page attribute setting unit 120 dynamically redistributes five pages to an event A with a large number of photographs and two pages to an event B with a small number of photographs. In a case where the user specifies “priority to a wedding”, the number of pages for the event “wedding” is increased to six, for example, to adjust the balance of the entire album.

At step S404, the image extraction unit 122 extracts images matching the attribute information of the displayed page. The attribute information is determined at step S402, and includes a period, an event tag, and the like. The target images are retrieved from the image database 130. For example, for a page “January”, photographs whose photographing dates and times belong to January are mainly extracted. For a page of “song 1”, photographs related to the first song in a live are extracted.

The recommendation control unit 124 gives priority to the extracted images in consideration of a user's preference, a family structure, location information, consecutively taken image information, and the like. The recommendation control unit 124 determines a recommended image in accordance with the given priority. For example, a photograph in which all family members are imaged as subjects is preferentially selected and presented. Alternatively, a photograph in which a subject is imaged as a large figure may be preferentially selected and presented. Alternatively, a photograph taken at a specific location may be preferentially selected and presented as a recommended image to photographs taken at other locations. For example, a photograph taken at a place other than a user's home may be preferentially presented. In a case where a plurality of previously stored images include consecutively taken photographs, only a representative image may be selected from the consecutively taken photographs and presented as a recommended image in order to avoid duplication. That is, the consecutively taken photographs are grouped by the image extraction unit 122, and the recommendation control unit 124 recommends an optimal representative image. The recommendation control unit 124 sorts the images in descending order of priority, and generates a list to be presented to the user.

At step S405, the user input reception unit 116 displays on the screen the recommended image list generated at step S404 by the recommendation control unit 124. Then, the user input reception unit 116 receives selection of an image to be arranged on a page from the recommended images.

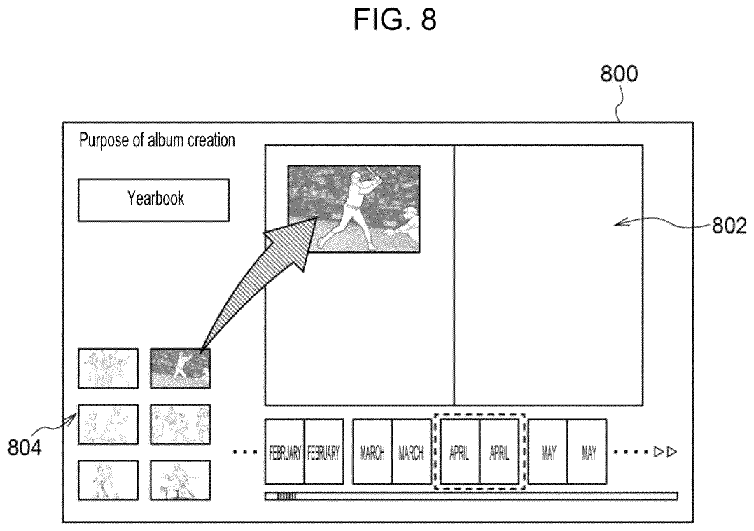

FIG. 8 is a diagram illustrating an example of an image recommendation screen 800 in which a recommended image list generated by the recommendation control unit 124 is displayed. When the user turns a page, the recommendation control unit 124 lists image candidates with reference to the attribute information associated with the page. For example, in FIG. 8, pages with a page attribute set to “April” are displayed in a page preview area 802. In a recommended image display field 804, photographs in accordance with user's context information are presented among the photographs whose photographing dates and times belong to April. For example, when the user desires to feature photographs of a location other than a user's home, photographs whose location information indicate “other than home” are preferentially displayed.

In this manner, every time the user switches pages of the album, the population of images having attribute information associated with each page is changed so as to present images corresponding to an attribute associated with the attribute information of the corresponding page. Among these images, only images selected in consideration of the context information are displayed in the recommendation list. Here, to “turn” or “switch” pages indicates the transition of the display screen of album pages. This reduces time and effort for screening a large number of photographs at once. This also prevents a bias in which only the top photographs stored in the storage device 106 are selected. In a case where the consecutively taken images are included, only one representative image is displayed in the recommendation list to prevent duplicated selection of similar photographs. This considerably reduces the workload of image selection.

The user selects an image to be arranged on a page from the presented recommended images. Once the user selects an image, the layout management unit 126 arranges the image selected by the user on a page. The layout management unit 126 automatically or semiautomatically generates an arrangement layout, and displays a preview screen. Even after the arrangement, the user may adjust the layout by an operation such as drag and drop, and the layout management unit 126 sequentially reflects changes.

After the user completes the final confirmation, the print instruction unit 128 generates album print data at step S406. The print instruction unit 128 integrates the layout information and image data of each page determined by the layout management unit 126. Then, the print instruction unit 128 converts the integrated data into a data format supported by the printer 200 and transmits the resultant data. Examples of the data format supported by the printer 200 include a portable document format (PDF) and other specific print processing instruction formats.

The printer 200 prints an album on an actual paper medium on the basis of the received print data. In this manner, a high-quality photo album is easily created.

While the above-described exemplary embodiment relates to a case where the page attribute is period information or event information, the present disclosure is not limited thereto. It is also possible to adopt a configuration in which a user uniquely sets tags and distributes pages in any units such as “summer music festival”, “family travel”, and “child's entrance ceremony”. Furthermore, an input of context information such as “focusing on a live performance of XX this year” may be received. Then, the album context management unit 118 may perform more detailed page distribution and recommendation logic.

Moreover, the album context management unit 118 may collect features of photographs deleted or selected by a user in the past or information of popular photographs among other users, and the recommendation control unit 124 may introduce a learning algorithm. In this manner, photographs that are likely to match the user's preference can be presented with high priority. Alternatively, large-scale data on the cloud may be referred, and the composition and subject information of photographs highly evaluated in the similar event may be learned.

In addition to printing of a physical album, output is possible also in an electronic book format or as a web album. The page data generated by the layout management unit 126 may be exported in a format such as PDF or HyperText Markup Language (HTML). The exported electronic data may be shared online with persons related to the user. With such extension, the user is able to enjoy the album on both paper media and digital media.

After the album editing program is installed or when an account is registered, an input of a family structure may be received. Then, the number of photographs is analyzed in accordance with the purpose of the album and the family structure so as to distribute pages. For example, in the case of a family album, a larger number of pages may be distributed to a period having a large number of photographs in which three or more family members are imaged and a period having a large number of photographs in which a child is imaged as a large figure so that memories are arranged in a balanced manner. The number of pages for a month with events related to a specific child may be increased. For example, the number of pages for months including consecutive holidays on the calendar, a firework festival, or an athletic meet is increased to realize flexible album creation in accordance with the events.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program according to the present disclosure may be provided as a program product.

In the embodiments above, the term “processor” is broad enough to encompass one processor or plural processors in collaboration which are located physically apart from each other but may work cooperatively. The order of operations of the processor is not limited to one described in the embodiments above, and may be changed.

The “system” according to the present exemplary embodiment includes both a system formed by a plurality of apparatuses and a system formed by a single apparatus. The present disclosure is also applicable to a program and a program product.

### APPENDIX

(((1)))

An information processing system comprising: a processor configured to: associate attribute information with each page of an album including a plurality of pages; select and present recommended images from images having attribute information associated with each page among a plurality of previously stored images; receive selection of images to be arranged on a corresponding page of the album from the recommended images; and arrange the selected images on the corresponding page of the album.
(((2)))

The information processing system according to (((1))), wherein the processor is configured to use time information as the attribute information associated with each page of the album, and select and present images having time information associated with each page from the plurality of previously stored images.
(((3)))

The information processing system according to (((2))), wherein the processor is configured to distribute the number of pages in the album to which each piece of time information is assigned, in accordance with the total number of pages of the album and the number of pieces of time information set as the attribute information.
(((4)))

The information processing system according to (((3))), wherein the processor is configured to adjust a page ratio in the album at which each piece of time information is assigned, in accordance with a ratio of images having time information associated with each page to the plurality of previously stored images.
(((5)))

The information processing system according to (((1))), wherein the processor is configured to receive album context information, and select and present images that correspond to the attribute information associated with each page and that are in accordance with the album context information from the plurality of previously stored images.
(((6)))

The information processing system according to (((5))), wherein the processor is configured to increase or reduce a page ratio at which each piece of attribute information is associated in accordance with the total number of pages of the album and the album context information.
(((7)))

The information processing system according to (((6))), wherein the album context information includes at least one of a creation purpose of an album, a user's preference, a family structure, and event information.
(((8)))

The information processing system according to any one of (((1))) to (((7))), wherein the processor is configured to change, every time a user switches pages of the album, a population of images having attribute information associated with each page so as to present images corresponding to an attribute associated with the page.
(((9)))

The information processing system according to any one of (((1))) to (((7))), wherein the processor is configured to select and present images in accordance with a user's preference, as the recommended images, preferentially to other images.
(((10)))

The information processing system according to any one of (((1))) to (((7))), wherein the processor is configured to select and present images captured at a specific location in accordance with location information of the images, as the recommended images, preferentially to images captured at other locations.
(((11)))

The information processing system according to any one of (((1))) to (((7))), wherein in a case where the plurality of previously stored images include consecutively captured images, the processor is configured to extract a representative image from the consecutively captured images and present the representative image as the recommended image.
(((12)))

A program causing a computer of an information processing system including a processor to execute a process, the process comprising: associating attribute information with each page of an album including a plurality of pages; selecting and presenting recommended images from images having attribute information associated with each page among a plurality of previously stored images; receiving selection of images to be arranged on a corresponding page of the album from the recommended images; and arranging the selected images on the corresponding page of the album.

What is claimed is:

1. An information processing system comprising:
a processor configured to:
associate attribute information with each page of an album including a plurality of pages;
select and present recommended images from images having attribute information associated with each page among a plurality of previously stored images;
receive selection of images to be arranged on a corresponding page of the album from the recommended images; and
arrange the selected images on the corresponding page of the album.

2. The information processing system according to claim 1, wherein the processor is configured to use time information as the attribute information associated with each page of the album, and select and present images having time information associated with each page from the plurality of previously stored images.

3. The information processing system according to claim 2, wherein the processor is configured to distribute the number of pages in the album to which each piece of time information is assigned, in accordance with the total number of pages of the album and the number of pieces of time information set as the attribute information.

4. The information processing system according to claim 3, wherein the processor is configured to adjust a page ratio in the album at which each piece of time information is assigned, in accordance with a ratio of images having time information associated with each page to the plurality of previously stored images.

5. The information processing system according to claim 1, wherein the processor is configured to receive album context information, and select and present images that correspond to the attribute information associated with each page and that are in accordance with the album context information from the plurality of previously stored images.

6. The information processing system according to claim 5, wherein the processor is configured to increase or reduce a page ratio at which each piece of attribute information is associated in accordance with the total number of pages of the album and the album context information.

7. The information processing system according to claim 6, wherein the album context information includes at least one of a creation purpose of an album, a user's preference, a family structure, and event information.

8. The information processing system according to claim 1, wherein the processor is configured to change, every time a user switches pages of the album, a population of images having attribute information associated with each page so as to present images corresponding to an attribute associated with the page.

9. The information processing system according to claim 2, wherein the processor is configured to change, every time a user switches pages of the album, a population of images having attribute information associated with each page so as to present images corresponding to an attribute associated with the page.

10. The information processing system according to claim 3, wherein the processor is configured to change, every time a user switches pages of the album, a population of images having attribute information associated with each page so as to present images corresponding to an attribute associated with the page.

11. The information processing system according to claim 4, wherein the processor is configured to change, every time a user switches pages of the album, a population of images having attribute information associated with each page so as to present images corresponding to an attribute associated with the page.

12. The information processing system according to claim 5, wherein the processor is configured to change, every time a user switches pages of the album, a population of images having attribute information associated with each page so as to present images corresponding to an attribute associated with the page.

13. The information processing system according to claim 6, wherein the processor is configured to change, every time a user switches pages of the album, a population of images having attribute information associated with each page so as to present images corresponding to an attribute associated with the page.

14. The information processing system according to claim 7, wherein the processor is configured to change, every time a user switches pages of the album, a population of images having attribute information associated with each page so as to present images corresponding to an attribute associated with the page.

15. The information processing system according to claim 1, wherein the processor is configured to select and present images in accordance with a user's preference, as the recommended images, preferentially to other images.

16. The information processing system according to claim 2, wherein the processor is configured to select and present images in accordance with a user's preference, as the recommended images, preferentially to other images.

17. The information processing system according to claim 3, wherein the processor is configured to select and present images in accordance with a user's preference, as the recommended images, preferentially to other images.

18. The information processing system according to claim 1, wherein the processor is configured to select and present images captured at a specific location in accordance with location information of the images, as the recommended images, preferentially to images captured at other locations.

19. The information processing system according to claim 1, wherein in a case where the plurality of previously stored images include consecutively captured images, the processor is configured to extract a representative image from the consecutively captured images and present the representative image as the recommended image.

20. A non-transitory computer readable medium storing a program causing a computer of an information processing system including a processor to execute a process, the process comprising:
associating attribute information with each page of an album including a plurality of pages;
selecting and presenting recommended images from images having attribute information associated with each page among a plurality of previously stored images;
receiving selection of images to be arranged on a corresponding page of the album from the recommended images; and
arranging the selected images on the corresponding page of the album.
